(19) United States
(12) Patent Application Publication
(10) Pub. No.: US 2011/0208506 A1
(43) Pub. Date: Aug. 25, 2011

(54) SYSTEMS AND METHODS FOR EMULATING NETWORK-ENABLED MEDIA COMPONENTS

(75) Inventors: Alexander Gurzhi, Cupertino, CA (US); Arkady Balter, San Francisco, CA (US)

(73) Assignee: SLING MEDIA INC., Foster City, CA (US)

(21) Appl. No.: 12/711,830

(22) Filed: Feb. 24, 2010

(51) Int. Cl. G06F 9/455; G06F 15/16

(52) U.S. Cl. 703/27; 709/227

(57) ABSTRACT

Methods, systems and devices are described for implementing a virtual placeshifting device, set top box (STB), media player or other hardware device using a general purpose computing system that executes a software application. A message is received at the general-purpose computer that requests a session with a client application. The session is established between an emulator application executing on the general-purpose computer and the client application, wherein the emulator application is configured to emulate an application programming interface associated with an actual hardware device. Communications are exchanged between the emulator application executing on the general-purpose computer and the client application throughout the session, wherein each the communications is consistent with the application programming interface (API) associated with the actual hardware device.

### TECHNICAL FIELD

This document relates to tools used in the development and/or testing of hardware components such as placeshifting devices, time shifting devices, set-top boxes and/or other devices that are able to communicate using a network.

### BACKGROUND

Today's consumers use many different types of media components and other hardware devices on a regular basis. A typical home, for example, generally receives media programming via a set top box (STB) or other receiver that receives and decodes direct broadcast satellite (DBS), cable, terrestrial broadcast and/or other programming. Consumers frequently obtain additional media content using any number of different media players, such as digital versatile disk (DVD) players or streaming media players that receive content over the Internet or another network. Received programming is often recorded on a digital video recorder (DVR) or the like to shift playback to a later time. Live and/or time shifted playback is typically provided using a conventional television or other display. In recent years, consumers are increasingly “place shifting” media content across communications networks for playback at portable computers, mobile phones, or other remote locations. Often, different media functions are combined into a single chassis: a set top box, for example, might provide time and/or place shifting features in addition to receiving and decoding television programming. Many modern consumers, then, make use of many different media components, including STBs or other receivers, DVRs, placeshifting devices, television displays and/or any number of other components to enjoy television and/or other media content. Consumers often use many different types of hardware devices in addition to the media components described above.

In recent years, many media and other hardware devices are increasingly becoming “network enabled” for communications using the Internet or another network. Network connectivity is now used to transmit or receive content, to receive instructions from a user or from another component, to obtain software updates, and/or for any number of other purposes. A conventional placeshifting device, for example, typically transmits a stream of received programming across local area, wide area, telephone and/or other network to a remote media player. Many other types of components similarly act as clients or servers on one or more networks.

Challenges can arise, however, in designing network-enabled hardware devices. Because such devices are often implemented with proprietary or other customized hardware designs, prototypes or other samples of new components can be expensive and difficult to obtain until the new design is finalized and manufactured. This limited hardware availability can lead to difficulties in designing and/or testing new applications that are compatible with the new hardware. This difficulty, in turn, can cause delays, as well as challenges in optimizing communications between client/server applications.

It is therefore desirable to create systems, methods and/or devices that allow for convenient development and/or testing of network-enabled devices. These and other desirable features and characteristics will become apparent from the subsequent detailed description and the appended claims, taken in conjunction with the accompanying drawings and this background section.

### BRIEF SUMMARY

Methods, systems and devices are described for implementing a virtual placeshifting device, set top box (STB), media player, media recorder or other hardware device using a general purpose computing system that executes a software application.

Various embodiments provide methods executable by a personal or other general-purpose computer. In various embodiments, a message is received at the general-purpose computer that requests a session with a client application. The session is established between an emulator application executing on the general-purpose computer and the client application, wherein the emulator application is configured to emulate an application programming interface associated with an actual hardware device. Communications are exchanged between the emulator application executing on the general-purpose computer and the client application throughout the session, wherein each the communications is consistent with the application programming interface (API) associated with the actual hardware device.

Other embodiments provide a method executable by a virtual placeshifting device operating on a personal or other general-purpose computing system to communicate with a media player via a digital network. The method suitably comprises receiving a request message from the media player at the general-purpose computer, wherein the message requests a placeshifting session between the media player and a placeshifting device; establishing the placeshifting session between an emulator application executing on the general-purpose computer and the media player; and emulating the placeshifting device with the emulator application executing on the general-purpose computer by exchanging communications between the emulator application and the media player via the digital network, wherein each of the communications provided by the emulator application is compatible with an application programming interface associated with the placeshifting device.

Still other embodiments provide a system configured to emulate an actual hardware component having an application programming interface. The system suitably comprises an interface to a digital communications network, a storage medium configured to store a general-purpose operating system and an emulator application compatible with the general-purpose operating system, and a general purpose processor. The general-purpose processor is suitably coupled in communication with the interface and the storage device, wherein the processor is configured to execute the general-purpose operating system and the emulator application to receive a message requesting a session between a client application and the emulator application via the interface, to establish the session between the emulator application and the client application, and to exchange communications between the emulator application and the client application via the interface, wherein the communications emulate the application programming interface associated with the actual hardware component.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a diagram of an exemplary environment in which an emulator application can operate; and

FIG. 2 is a diagram of an exemplary process for using an emulator application to emulate a media component or other device.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

According to various embodiments, a “virtual” representation of a media component or other hardware device is provided using emulation software executing on a personal computer or other general purpose computing system. The emulator application emulates an application programming interface (API) used in the actual hardware device, thereby providing a working model for the API in a format that is executable on a conventional computing system. By providing convenient access to the API, other products that interact with the API can be developed and tested even when specialized hardware is not readily available. Unlike the actual devices that are typically implemented using proprietary or other specialized hardware, then, the virtual device that is implemented in emulator software may be quickly and easily distributed and updated to allow development or testing of client applications, server applications, or other products that interact with the actual hardware device.

Indeed, the virtual device may have any number of uses. In various embodiments, the emulator application can be readily transmitted to a developer to allow compatibility testing between client and/or server products that interact with the actual hardware device, as desired. A virtual placeshifting device, for example, could be provided to a media player developer to assist in the design and testing of media players that are compatible with the API of the actual placeshifting device. This virtual model could be provided even when an actual implementation of the hardware device has not been built, or is not otherwise readily available. The virtual device therefore serves in some embodiments as a “working model” of the device API that can be of great benefit to developers and testers.

The virtual device may also be useful in developing and testing the device API itself. By initially emulating the API in a virtual software model, certain issues can be identified and addressed before expensive hardware and/or embedded software is produced. In many situations the virtual component can allow simulation and other testing of a proprietary or other relatively “closed” platform using a similar (if not identical) API running on an open platform such as a personal computer or the like.

Other embodiments may use the virtual device to test network conditions associated with installed actual devices. A technician, for example, could use emulator software installed on a laptop or similar computer to provide a second device on a home or other network where an actual device is installed. The virtual component may be useful in identifying or isolating network issues, or in determining whether an installed device is problematic for any reason. Other embodiments may provide virtual devices as relatively inexpensive “free samples” to potential customers, or for any other purpose. By providing a convenient yet accurate model of the device API, then, various embodiments are able to achieve any number of benefits to developers, testers, installers, users and/or others.

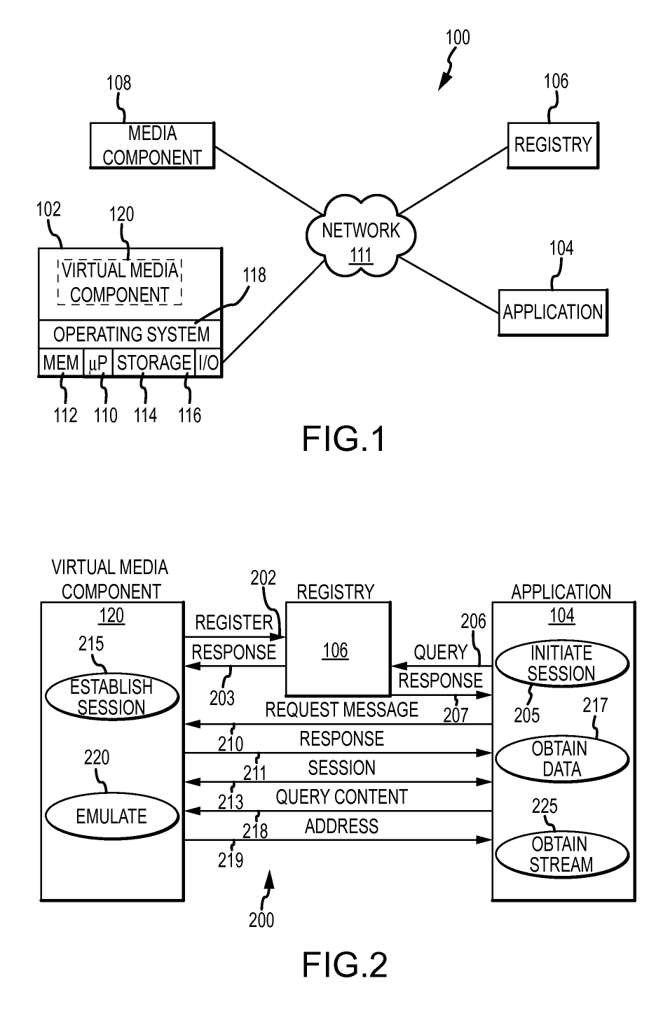

Turning now to the drawing figures and with initial reference to FIG. 1, an exemplary environment 100 for developing, testing and/or deploying network-enabled hardware devices suitably includes a general purpose computer system 102 that executes a emulator application 120. (Emulator application 120 is also referenced herein as a “virtual device 120”.) FIG. 1 also shows a hardware or software client application 104 (e.g., a media player or the like) communicating with an actual hardware device 108 (also referenced as “actual device 108”). In this example, client application 104 communicates with actual device 108 and/or virtual device 120 over a network 111. In some implementations, client application 104 obtains addresses on network 111 for actual device 108 and/or virtual device 120 using an address server or other registry 106, as appropriate.

In the illustration of FIG. 1, it may be desirable to test the ability of client application 104 to communicate with one or more actual devices 108. Client application 104 may be in development, for example. If an actual device 108 having the desired configuration is not readily available for such testing, a virtual device 120 can be provided to emulate the API of actual device 108, thereby allowing for development and testing of client application 104 even when a suitable actual device 108 is not available.

Actual device 108 is any component or other special-purpose device that is capable of communicating with application 104 via network 111. In various embodiments, actual device 108 is implemented using at least some special-purpose hardware or other logic, such as any sort of embedded software, firmware and/or application-specific integrated circuitry. Although some actual devices 108 may include some general-purpose parts or other features (e.g., digital signal processors or other general purpose circuitry), devices 108 will typically be implemented within a specific housing or chassis and will be intended to provide specific data-processing or other features. A conventional general-purpose personal computer, for example, would not by itself be considered an “actual device” 108, although some “actual devices” 108 may include conventional bus architectures, interfaces, processors or other internal circuitry, operating systems and/or other features that may have common application in personal computing. Examples of actual hardware devices 108 that may be used in various embodiments include, without limitation, media components such as placeshifting devices, set top boxes (STBs) or other television receivers, digital video recorders (DVRs) or other time shifting devices, media players and/or other network-enabled devices that are provided for the express purpose of processing video or other media content. Several detailed examples of placeshifting devices are described in U.S. Patent Publication No. 2006/0095471, although the concepts described herein could be used in conjunction with different products that are available from any source, and with devices 108 that implement functions other than placeshifting.

Virtual device 120, in contrast, is any software implementation that emulates the API(s) of one or more actual media components 108. In various embodiments, virtual device 120 is implemented using conventional software constructs that can be executed on a general-purpose computer system 102. In the example of FIG. 1, computer system 102 is a conventional personal computer (PC) that may be obtained from any number of retailers. This example shows computer system 102 as having a standard processor 110 as may be commonly found in conventional PCs, as well as conventional memory 112, mass storage 114 and input/output (I/O) features 116. Mass storage 114 generally includes any sort of conventional storage media, such as a magnetic or optical disc drive, a solid state drive, and/or the like. I/O features 116 typically include a conventional wired and/or wireless network interface, such as any sort of network interface card (NIC) that is compatible with IEEE 802.3, 802.11 and/or other communications protocols used on network 111.

Typically, computer system 102 has a locally-stored operating system 118 that allows the software implementation of virtual device 120 to access hardware 110-116 and other features of computer system 102, as appropriate. Examples of operating systems 118 that may be used with various embodiments could include, without limitation, any versions of the WINDOWS, OSX, LINUX or other operating systems, such as any operating system that is substantially compliant with POSIX standards. “Substantially compliant” in this context recognizes that some operating systems may not be perfectly compliant with then-prevailing POSIX standards, but may nevertheless be sufficiently compliant to implement the features described herein. Examples of substantially-compliant POSIX operating systems used in some embodiments (e.g., any versions of UNIX, LINUX, OSX and/or the like) may support such features as multi-threading, socket-level programming, daemon processes and/or the like.

Emulator application 120 is implemented using any conventional software applications, applets, objects, routines, libraries, scripts and/or the like, including any sort of complied or interpreted software code. In various embodiments, emulator application 120 is implemented at least in part with a conventional WINDOWS service that is compatible with the WINDOWS operating system 118. Other embodiments based upon POSIX or similar operating systems 118 may use conventional daemons or other processes, as appropriate. Generally speaking, emulator application 120 contains sufficient logic to receive requests for connections, to establish connections to client applications 104 or the like, and to emulate the API(s) of actual hardware device(s) 108. In embodiments wherein emulator application 120 communicates with client applications 104 over network 111, for example, a socket connection to a particular port can be used to transmit and receive messages via the network interface or other I/O features 116, as appropriate. Other embodiments may implement the various functions described herein using other mechanisms and techniques.

Network 111 is any digital or other communications network capable of transmitting messages between senders and receivers. In various embodiments, network 111 may represent a wide area network, a local area network, and/or any combination of wide and local area networks. Other embodiments can include any number of public or private data connections, links or networks supporting any number of communications protocols. Network 111 may include the Internet, for example, or any other network based upon TCP/IP or other conventional protocols. In many embodiments, environment 100 is wholly or largely implemented within a relatively small geographical area (e.g., within a home, office or other structure). In such embodiments, network 111 may represent a conventional local area network, such as one or more IEEE 802.3 and/or IEEE 802.11 networks. Network 111 as shown in FIG. 1, then, is intended to broadly encompass any digital communications network(s), systems or architectures for transmitting data between the various components of environment 100.

FIG. 1 shows a client application 104 that communicates with actual and virtual devices 108 and 120 using network 111. Equivalent embodiments, however, may not use network communications at all. Different client applications 104, for example, may simply reside on general purpose computer system 102, with communications between the application 104 and virtual device 120 occurring mostly, if not entirely, within computer system 102. Such communications may be facilitated, for example, by operating system 118. Moreover, although FIG. 1 shows a “client” application 104, equivalent embodiments could use similar constructs and techniques to communicate with different types of applications. That is, emulation of the API could be equivalently used for any purpose, including any communications where the emulated device acts as a client, a server, a peer, or in any other manner.

Emulation of the API associated with actual device 108 may be implemented in any manner. In various embodiments, the actual software, firmware or other code used in an actual hardware device 108 may be executed on computing system 102 to emulate the API using any sort of appropriate translation, adaptation or other abstraction features. In other embodiments, however, separate code may be developed for the relatively open environment of the general purpose computer 102. Such code may be easier and/or faster to develop than more specialized code that may be used in certain types of actual devices 108; different embodiments may emulate the API of actual device 108 in any other manner.

FIG. 2 shows an exemplary process 200 in which a client or other application 104 establishes a session 213 with virtual device 120. As noted above, communications between application 104 and virtual device 120 may be carried out over network 111, internally within computing system 102, or in any other manner.

In the exemplary embodiment shown in FIG. 2, the virtual device 120 initially makes itself known on network 111 by transmitting a registration message 202 to registry 106. Registry 106 appropriately responds to message 202 by adding virtual device 120 to the database of available services, and by transmitting an appropriate confirmation response 203. This registry 106 may be a database or other server that assists applications operating on network 111 in finding appropriate media components 108 and/or 120. Registry 106 may also perform authentication, registration, address translation and/or any other actions as needed.

Application 104 initiates sessions with one or more virtual media components 120 in any manner (function 205). In various embodiments, client application 104 initially queries registry 106 (message 206) and receives a response 207 that contains the network address of an actual device 108 or a virtual device 120. As noted above, other embodiments may simply use inter-process communications features of operating system 118 or other faculties to communicate between application 104 and virtual device 120.

The various messages and other communications 210, 211, 213, 218, 219 exchanged between application 104 and virtual device 120 may be formatted in any manner. In various embodiments, each of the communications exchanged between application 104 and virtual device 120 are formatted in accordance with the application programming interface typically used by actual device 108. While the formatting and schema of the particular API will vary from embodiment to embodiment, various implementations may use hypertext transport protocol (HTTP) and/or extensible markup language (XML) or the like to format data contained within each message. Other embodiments may similarly use SOAP, XHTML and/or the like to format data contained within each communication. The virtual device 120 therefore emulates the actual device 108 by using the same API as the actual device 108 (function 220). This API may include, for example, application programming interface (API) any software interfaces that enable interaction with other software. The API may be emulated using any appropriate applications, libraries and/or operating system features to determine the vocabulary, calling conventions, formats and/or other features that client applications 104 would employ to access or use services of an actual device 108. The emulated API may include any specifications for processing routines, data structures, object classes, communications protocols or other features used to communicate between application 104 and actual device 108.

In the exemplary exchange shown in FIG. 2, application 104 sends a request message 210 that is formatted in accordance with the API of the actual device 108 to the address received in response 207. This message 210 is received by the virtual device 120 using, for example, the NIC or other I/O features 116, as well as operating system 118. The virtual device 120 is able to parse the message 210 to establish a communications session 213 between the virtual device 120 and the application 104 (function 215). In various embodiments, virtual device 120 transmits an appropriate response 211 to application 104 that allows session 213 to be established between application 104 and virtual device 120.

Communications exchanges via session 213 may vary significantly from embodiment to embodiment. The exemplary embodiment shown in FIG. 2, for example, shows application 104 obtaining additional data (function 217) that can be used to obtain a place shifted media stream or file, or any other appropriate information. In this example, application 104 places a query or request for content 218 via session 213. Virtual device 120 suitably responds to the query by providing a uniform resource locator (URL) or other suitable address that identifies a media stream, file or other content that can be obtained (function 225) by application 104. Equivalent embodiments may provide different functions using different types of virtual devices 120 and/or features emulated within function 220. In addition to the placeshifting examples provided herein, any number of other implementations may be provided across a wide array of alternate embodiments.

As noted at the outset, the virtual media device 120 may be provided for many different types of media devices, and for many different purposes. The “working model” of the API may be of substantial benefit in designing or testing the emulated API design, or in identifying issues for subsequent development. Because the virtual device 120 is implemented with emulator software, it may be readily distributed and shared in any manner. This may allow supplier, vendors or contractors to conveniently access new APIs before custom hardware is available. Many other features may be fashioned as well.

Various systems, devices and techniques are therefore described that provide virtual implementations of placeshifting devices, set top boxes and/or other network-enabled but special-purpose hardware devices. As used herein, the word “exemplary” means “serving as an example, instance, or illustration.” Any implementation described herein as exemplary is not necessarily to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method executable by a general-purpose computer, the method comprising:
receiving a message at the general-purpose computer that requests a session with a client application;
establishing the session between an emulator application executing on the general-purpose computer and the client application, wherein the emulator application is configured to emulate an application programming interface associated with an actual hardware device; and
exchanging communications between the emulator application executing on the general-purpose computer and the client application throughout the session, wherein each of the communications is consistent with the application programming interface associated with the actual hardware device.

2. The method of claim 1 further comprising registering the emulator application with a registry prior to receiving the message from the client application.

3. The method of claim 2 wherein the actual hardware device is a special purpose hardware device and wherein the emulator application is registered with the registry.

4. The method of claim 1 wherein the general-purpose computer is a personal computer configured to execute a general purpose operating system, and wherein the emulator application is compatible with the general purpose operating system.

5. The method of claim 4 wherein the general purpose operating system is a WINDOWS operating system and wherein the emulator application comprises a WINDOWS service.

6. The method of claim 4 wherein the emulator application comprises a daemon.

7. The method of claim 1 wherein the actual hardware device is a set-top box.

8. The method of claim 1 wherein the actual hardware device is a special-purpose hardware component.

9. The method of claim 1 wherein the client application is a media player application and the actual hardware device is a placeshifting device.

10. A method to communicate with a media player via a digital network, the method comprising:
receiving a request message from the media player at a general-purpose computer, wherein the request message requests a placeshifting session;
establishing the placeshifting session between an emulator application executing on the general-purpose computer and the media player; and
emulating an actual placeshifting device with the emulator application executing on the general-purpose computer by exchanging communications between the emulator application and the media player via the digital network, wherein each of the communications provided by the emulator application is compatible with an application programming interface associated with the actual placeshifting device.

11. The method of claim 10 wherein the emulator application provides a virtual model of the actual placeshifting device.

12. The method of claim 10 wherein the emulating comprises providing a uniform resource locator of a media stream from the emulator application to the media player.

13. The method of claim 10 wherein at least some of the communications are configured to establish a streaming media connection to the media player in accordance with the application programming interface.

14. A system configured to emulate an actual hardware device having an application programming interface, the system comprising:
an interface to a digital communications network;
a storage medium configured to store a general-purpose operating system and an emulator application compatible with the general-purpose operating system; and
a general-purpose processor coupled in communication with the interface and the storage medium, wherein the general-purpose processor is configured to execute the general-purpose operating system and the emulator application to receive a message requesting a session between a client application and the emulator application via the interface, to establish the session between the emulator application and the client application, and to exchange communications between the emulator application and the client application via the interface, wherein the communications emulate the application programming interface associated with the actual hardware device.

15. The system of claim 14 wherein the system is implemented with a personal computer, the general-purpose operating system is a WINDOWS operating system, and the emulator application comprises a WINDOWS service.

16. The system of claim 14 wherein the system is implemented with a personal computer, the general-purpose operating system is a substantially POSIX-compliant operating system, and the emulator application comprises a daemon.

17. The system of claim 14 wherein the general-purpose processor is further configured to update the software application to reflect changes in the application programming interface.

18. The system of claim 14 wherein the actual hardware device is a special purpose hardware component.

19. The system of claim 14 wherein the actual hardware device is a placeshifting device.

20. The system of claim 19 wherein the emulator application provides a virtual representation of the placeshifting device.
